(19) United States
(12) Patent Application Publication
(10) Pub. No.: US 2019/0095776 A1
(43) Pub. Date: Mar. 28, 2019

(54) Efficient data distribution for parallel processing

(71) Applicant: Mellanox Technologies, Ltd., Yokneam (IL)

(72) Inventors: Boaz Kfir, Meitar (IL); Noam Eilon, Motza Illit (IL); Meital Tsechanski, Lehavim (IL); Itsik Levi, Shapir (IL)

(21) Appl. No.: 15/716,761

(22) Filed: Sep. 27, 2017

(51) Int. Cl. G06N 3/04; G06F 9/30

(52) U.S. Cl. CPC G06N 3/04; G06F 9/30101

(57) ABSTRACT

Computational apparatus includes an input buffer configured to hold a first array of input data and an output buffer configured to hold a second array of output data computed by the apparatus. A plurality of processing elements are each configured to compute a convolution of a respective kernel with a set of the input data that are contained within a respective window and to write a result of the convolution to a corresponding location in a respective plane of the output data. One or more data fetch units each read one or more segments of the input data from the input buffer. A shift register delivers the segments of the input data in succession to each of the processing elements in an order selected so that the respective window of each processing element slides in turn over a sequence of window positions covering the first array.

### FIELD OF THE INVENTION

The present invention relates generally to computational devices, and specifically to apparatus and methods for high-speed parallel computations.

### BACKGROUND

Convolutional neural nets (CNNs) are being used increasingly in complex classification and recognition tasks, such as large-category image classification, object recognition, and automatic speech recognition. State-of-the-art CNNs are typically organized into alternating convolutional and max-pooling layers, followed by a number of fully-connected layers leading to the output. This sort of architecture is described, for example, by Krizhevky et al., in “ImageNet Classification with Deep Convolutional Neural Networks,” published in Advances in Neural Information Processing Systems (2012).

In the convolutional layers of the CNN, a three-dimensional (3D) array of input data (commonly referred to as a 3D matrix or tensor) of dimensions M×N×D is convolved with H kernels of dimension k×k×D and stride S. Each 3D kernel is shifted in strides of size S across the input volume. Following each shift, every weight belonging to the 3D kernel is multiplied by each corresponding input element from the overlapping region of the 3D input array, and the products are summed to create an element of a 3D output array. After convolution, an optional pooling operation is used to subsample the convolved output.

General-purpose processors are not capable of performing these computational tasks efficiently. For this reason, special-purpose hardware architectures have been proposed, with the aim of parallelizing the large numbers of matrix multiplications that are required by the CNN. One such architecture, for example, was proposed by Zhou et al., in “An FPGA-based Accelerator Implementation for Deep Convolutional Neural Networks,” 4th International Conference on Computer Science and Network Technology (ICCSNT 2015), pages 829-832. Another example was described by Zhang et al., in “Optimizing FPGA-based Accelerator Design for Deep Convolutional Neural Networks,” Proceedings of the 2015 ACM/SIGDA International Symposium on Field-Programmable Gate Arrays (2015), pages 161-170.

### SUMMARY

Embodiments of the present invention that are described hereinbelow provide improved apparatus and methods for performing parallel computations over large arrays of data.

There is therefore provided, in accordance with an embodiment of the invention, computational apparatus, including an input buffer configured to hold a first array of input data and an output buffer configured to hold a second array of output data computed by the apparatus. A plurality of processing elements are each configured to compute a convolution of a respective kernel with a set of the input data that are contained within a respective window and to write a result of the convolution to a corresponding location in a respective plane of the output data. One or more data fetch units are each coupled to read one or more segments of the input data from the input buffer. A shift register is coupled to receive the segments of the input data from the data fetch units and to deliver the segments of the input data in succession to each of the processing elements in an order selected so that the respective window of each processing element slides in turn over a sequence of window positions covering the first array, whereupon the result of the convolution for each window position is written by each processing element to the location corresponding to the window position in the respective plane in the output buffer.

In the disclosed embodiments, the processing elements are configured to compute a respective line of the output data in the second array for each traversal of the first array by the respective window, and the data fetch units and the shift register are configured so that each of the segments of the input data is read from the input buffer no more than once per line of the output data and then delivered by the shift register to all of the processing elements in the succession. Additionally or alternatively, the shift register is configured to deliver the segments of the input data to groups of the processing elements such that in any given processing cycle of the processing elements, adjacent groups of the processing elements in the succession process the input data in different, respective windows.

In some embodiments, the shift register is configured to deliver the segments of the input data to groups of the processing elements such that in any given processing cycle of the processing elements, each segment of the input data is passed from one group of the processing elements to an adjacent group of the processing elements in the succession. In one such embodiment, the shift register includes a cyclic shift register, such that a final processing element in the succession is adjacent, with respect to the cyclic shift register, to an initial processing element in the succession.

In a disclosed embodiment, each processing element includes one or more multipliers, which multiply the input data by weights in the respective kernel, and an accumulator, which sums products output by the one or more multipliers.

The input data held by the input buffer may include pixels of an image or intermediate results, corresponding to feature values computed by a preceding layer of convolution.

There is also provided, in accordance with an embodiment of the invention, a method for computation, which includes receiving a first array of input data in an input buffer and transferring successive segments of the input data from the input buffer into a shift register. The segments of the input data are delivered from the shift register in succession to each of a plurality of processing elements, in an order selected so that a respective window of each processing element slides in turn over a sequence of window positions covering the first array. Each processing element computes a convolution of a respective kernel with a set of the input data that are contained within the respective window, as the respective window slides over the sequence of window positions, and writes a result of the convolution for each window position to a corresponding location in a respective plane in a second array of output data in an output buffer.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a convolutional neural network (CNN), in accordance with an embodiment of the invention;

FIG. 2 is a block diagram that schematically shows details of a computational layer in a CNN, in accordance with an embodiment of the invention; and

FIG. 3 is a block diagram that schematically illustrates operation of a shift register in a CNN, in accordance with an embodiment of the invention.

### DETAILED DESCRIPTION OF EMBODIMENTS

Hardware-based CNN accelerators comprise multiple, parallel processing elements, which perform repeated convolution computations (multiply and accumulate) over input data that are shared among the processing elements. In general, each processing element applies its respective kernel to a respective window of the data, which slides over the input data in such a way that all of the processing elements operate on the entire range of the input data. The processed results are then passed on to the next processing layer (typically line by line, as processing of each line is completed). This processing model applies both to the first layer of the CNN, in which the processing elements operate on actual pixels of image data, for example, and to subsequent layers, in which the processing elements operate on intermediate results, such as feature values, which were computed and output by a preceding convolutional layer. The term “input data,” as used in the present description and in the claims, should thus be understood as referring to the data that are input to any convolutional layer in a CNN, including the intermediate results that are input to subsequent layers.

For optimal performance of a CNN accelerator, it is desirable not only that the processing elements perform their multiply and accumulate operations quickly, but also that the input data be delivered rapidly from the memory where they are held to the appropriate processing elements. Naïve solutions to the problem of data delivery typically use high-speed fetch units with large fan-outs to reach all of the processing elements in parallel, for example, or complex crossbar switches that enable all processing units (or groups of processing units) to fetch their data simultaneously. These solutions require complex, costly high-frequency circuit designs, using large numbers of logic gates and consequently consuming high power and dissipating substantial heat.

Embodiments of the present invention that are described hereinbelow address the challenge of delivering input data, such as pixel and kernel coefficients, to a large number of calculation units. The disclosed embodiments provide methods for delivering pixel data, for example, to many calculation units while minimizing the frequency of read accesses to input data buffers, as well as maintaining physical locality to alleviate connectivity issues between the input data buffers and the many calculation units.

Embodiments of the present invention provide an efficient mechanism for orderly data distribution among the processing elements that supports high-speed processing while requiring only low-frequency memory access. This mechanism reduces connectivity requirements between the buffer memory and the processing elements and is thus particularly well suited for implementation in an application-specific integrated circuit (ASIC) or field-programmable gate array (FPGA). The disclosed embodiments are useful in both initial and intermediate convolutional layers of a CNN, as described in detail hereinbelow. Furthermore, these techniques of data distribution among processing elements may alternatively be applied, mutatis mutandis, in other sorts of computational accelerators that use parallel processing.

In the disclosed embodiments, computational apparatus comprises one or more convolutional layers. In each layer, an input buffer holds an array of input data, while an output buffer receives an array of output data computed in this layer (and may serve as the input buffer for the next layer). Each of a plurality of processing elements in a given convolutional layer computes a convolution of a respective kernel with a set of the input data that are contained within a respective window, and writes the result of the convolution to a corresponding location in a respective plane of the output data. The respective windows of the processing elements in each computational cycle are staggered so as to support a model in which each line of input data need be read from the input buffer no more than once for each line of output data to which it contributes, i.e., no more than once for each traversal of the array of input data by the respective windows. (For example, when 3×3 kernels are to operate on the input data, each line may be read three times.) Each such line of input data is fed to a group of one or more processing elements, and is then delivered by a shift register to all of the other processing elements in succession. (The term “group” should be understood, in the context of the present description and in the claims, to include a group consisting of only a single element.)

To implement this scheme, one or more data fetch units are each coupled to read one or more segments of the input data from the input buffer. (A “segment” in this context refers to a part of a line of input data.) For efficient data access, the number of fetch units can be equal to the number of groups of processing elements, such that within each group, the processing elements process the data in the same window in parallel. A shift register receives the segments of input data from the data fetch units and delivers the segments of the input data in succession to the processing elements. The order of delivery matches the staggering of the respective windows, so that the respective window of each processing element slides in turn over a sequence of window positions covering the entire array of input data. Each processing element writes the result of its convolution for each window position to the location corresponding to the window position in the respective plane in the output buffer.

For efficient implementation of this sort of scheme, the input data are partitioned into appropriate segments and lines in the input buffer. The shift register delivers the segments of input data to the processing elements such that in any given processing cycle of the processing elements, adjacent groups of the processing elements in the succession process the input data in different, staggered windows. Typically, in any given processing cycle, each segment of input data is passed from one group of processing elements to the adjacent group in the succession. In a disclosed embodiment, the shift register comprises a cyclic shift register, wherein the final processing element in the succession is adjacent, with respect to the cyclic shift register, to the initial processing element in the succession.

Although the embodiments described below relate, for the sake of clarity and concreteness, to a convolutional neural network, the principles of the present invention are similarly applicable to other sorts of computations that generate multi-data output arrays based on multi-data input arrays. Specifically, the architecture described below is useful in applications, such as computing sums of products of multiplications, in which each element in the output array is calculated based on multiple elements from the input array, and the computation is agnostic to the order of the operands.

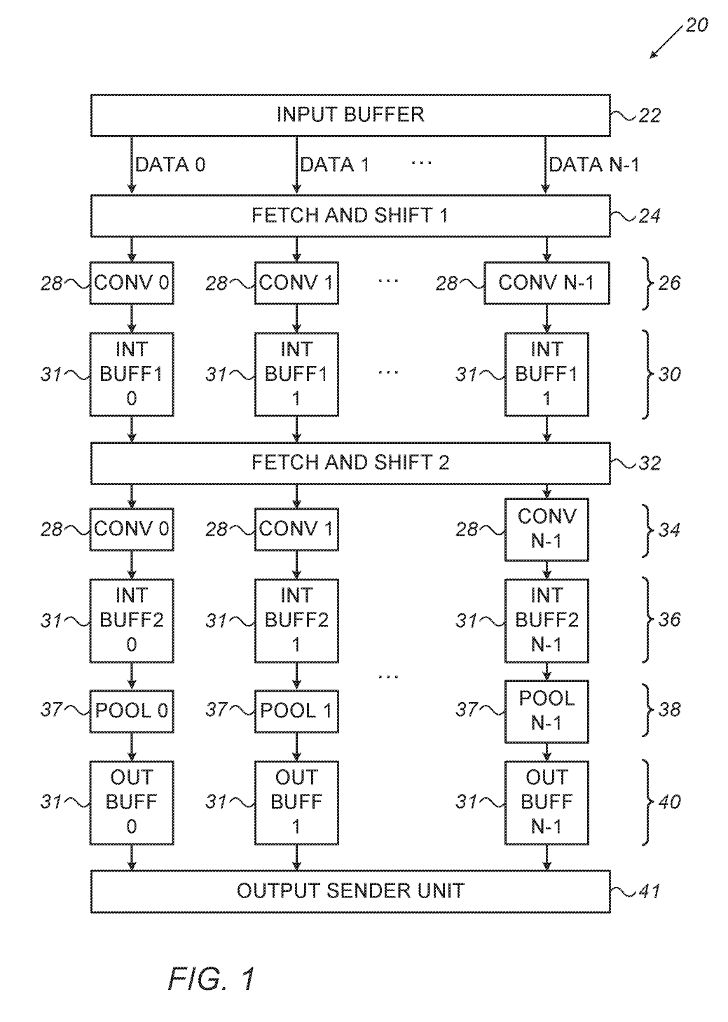

FIG. 1 is a block diagram that schematically illustrates a convolutional neural network (CNN) 20, in accordance with an embodiment of the invention. An input buffer layer 22, comprising a suitable memory array, receives input data, such as pixels of a color image. A fetch and shift stage 24 reads N segments of the data from buffer layer 22 and delivers the data to a convolution stage 26, comprising N groups of processing elements 28. Stages 24 and 26 constitute the first convolutional layer of CNN 20. As noted earlier, each group of processing elements 28 may comprise multiple processing elements, which operate in parallel on the same sliding window of data; but in the description that follows, it is assumed for the sake of simplicity that each such “group” consists of only a single processing element. The data in the input array are typically multi-dimensional, comprising three color components per pixel, for example.

Each processing element 28 convolves the input data in its sliding window with a respective kernel and writes the result to a respective plane, held in a respective buffer 31 within an intermediate buffer layer 30, in a location corresponding to its current window location. Processing elements 28 may also comprise a rectified linear unit (ReLU), as is known in the art, which converts negative convolution results to zero, but this component is omitted for the sake of simplicity. Processing elements 28 may compute their respective convolutions over windows centered, in turn, at every pixel in the input data array, or they may alternatively slide over the input data array with a stride of two or more pixels per computation.

The second convolutional layer of CNN comprises a fetch and shift stage 32 and a convolution stage 34, which are similar in structure and functionality to stages 24 and 26. For this layer, intermediate buffer 30 serves as the input buffer, while a second intermediate buffer layer 36, comprising a respective buffer 31 for each processing element in stage 34, serves as the output buffer. Pooling elements 37 in a pooling layer 38 then downsample the data in each buffer 31 within layer 36, for example by dividing the data into patches of a predefined size and writing the largest data value in each patch, as is known in the art, to respective buffers 31 in an output buffer layer 40, whose size is thus reduced relative to buffer layer 36. (Pooling elements pool the data along the Y-axis, while processing elements 28 can also pool the data along the X-axis, i.e., along the lines of the buffer.)

Output buffer layer 40 may serve as the input to yet another convolution stage or to a subsequent pooling layer (not shown) leading to the final result of the CNN. (Pooling may also take place following convolution stage 26, although this feature is not shown in FIG. 1.) An output sender unit 41 collects the processed data from output buffer layer 40 and sends the results to the next processing stage, whatever it may be.

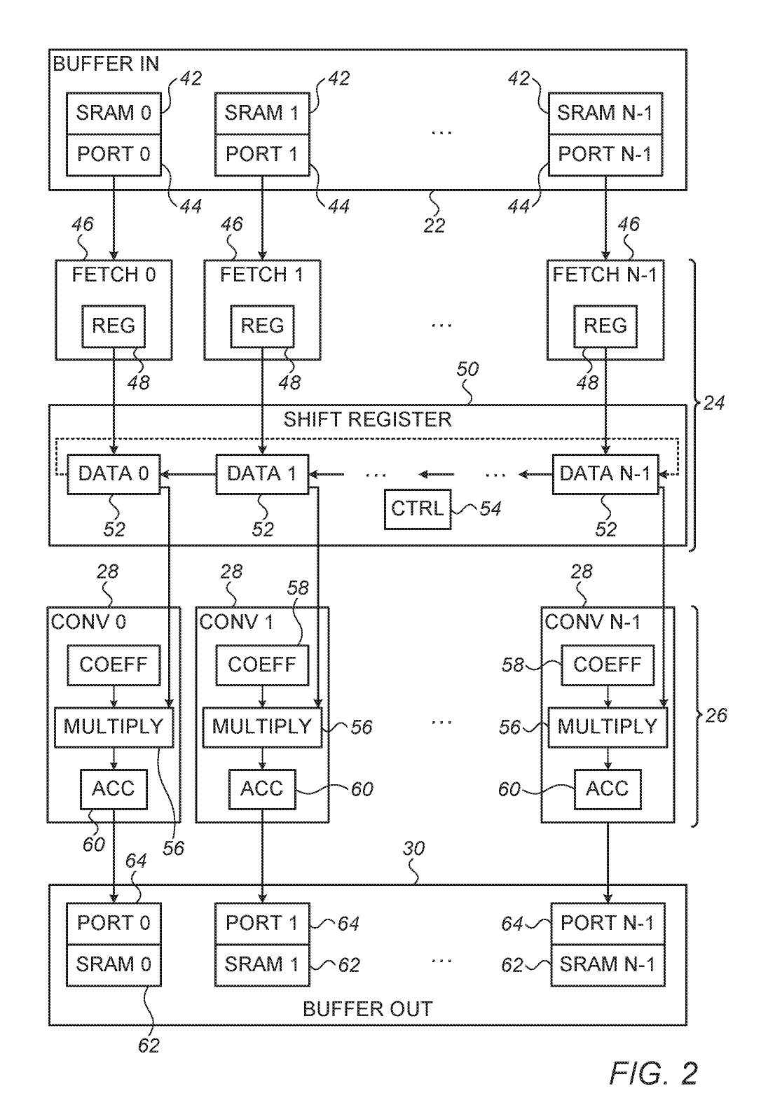

FIG. 2 is a block diagram that schematically shows details of one of the convolutional layers in CNN 20, in accordance with an embodiment of the invention. In this example, buffer layer 22 comprises N buffers 42 of static random access memory (SRAM), each with a single read/write port 44. Each buffer 42 holds data in a corresponding plane, such as a channel of pixel data, arranged sequentially, for example in image lines of 1280 pixels.

Fetch and shift stage 24 comprises N fetch units 46 and a shift register 50. Each fetch unit 46 reads a respective segment of a line of data from port 44 of a corresponding buffer 42 of buffer layer 22 into a register 48. In the pictured example, stage 24 includes a single fetch unit 46 for each processing element 28. (In alternative embodiments, not shown in the figures, each fetch unit 46 can serve a corresponding group of two or more processing elements, which operate concurrently on the same window of data. Additionally or alternatively, a given fetch unit may read data from multiple buffers, or multiple fetch units may access the same buffer.) Each fetch unit 46 loads its segment of data into a corresponding entry 52 in shift register 50, which cycles the data among entries 52 under instructions of a controller 54.

In each cycle of computation by convolution stage 26, the segment of data held in each entry 52 is passed both to the corresponding processing element 28 and to the next entry 52 in shift register 50. Thus, for each line of output data that is written to buffer layer 30, each segment of the input data is read from buffer layer 22 once and then delivered by the shift register 50 to all of processing elements 28 in succession. In each processing cycle, in other words, each segment of input data is passed from one processing element 28 to the next, adjacent processing element in the succession. Shift register 50 is cyclic, meaning that the final processing element in the succession (element N-1) is adjacent, with respect to the cyclic shift register, to the initial processing element (element 0).

After N cycles, all of the N segments of data will have passed through the entire shift register 50 and been processed by all N processing elements 28. At this point, fetch units 46 will have already loaded the next segment of data from buffers 42 into registers 48. The segment of data is loaded from register 48 into entries of shift register 50 immediately to ensure maximal calculation rate. This load and shift process continues until all the lines of data in buffer layer 22 have been read and processed.

Each processing unit 28 comprises at least one multiplier 56, which multiplies a number of successive pixels of input data (typically from multiple different lines and/or buffers 42) by a matrix of corresponding coefficients 58 (also referred to as weights). For example, assuming each line of input data to comprise three pixels having three color components each, coefficients 58 may form a kernel of 3×3×3 weights. Alternatively, in the second convolution stage 34 (FIG. 1), each line of input data may comprise three elements of feature data having N feature values each, and coefficients 58 may form a kernel of 3×3×N weights. Further alternatively, other kernel sizes may be used. An accumulator 60 sums the products computed by multiplier 56 and writes the result via a port 64 to a corresponding segment 62 of SRAM in buffer 30.

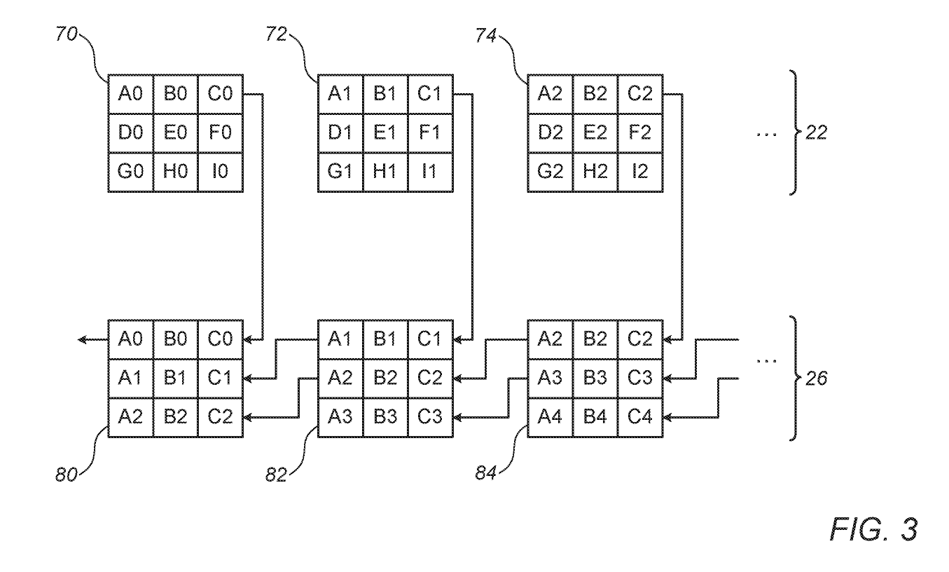

FIG. 3 is a block diagram that schematically illustrates operation of shift register 50, in accordance with an embodiment of the invention. The upper row of 3×3 matrices in FIG. 3 represent data lines 70, 72, 74, . . . , which are respectively held in segments 0, 1, 2, . . . , N-1 of input buffer layer 22, while the lower row of 3×3 matrices illustrate windows 80, 82, 84, . . . , of data processed by processing elements 0, 1, 2, . . . , N-1. Windows 80, 82 and 84 of the data that are processed by adjacent processing elements 28 in the processing cycle that is shown in FIG. 3 can be seen to be staggered, as the line of data (A2,B2,C2) appears in all three windows.

Each data line 70, 72, 74 in the pictured example contains red, green and blue data components for three adjacent pixels. For example, the triad (A0,B0,C0) may represent the pixels in the first image line of the first three rows (A, B and C) of one channel (for example, the red component) of the input image; while (A1,B1,C1) represents the channel, and so forth. Fetch units 46 each load one segment of data into registers 48, following which shift register 50 distributes the segments from all fetch units in succession to processing elements 28. Thus, during the first three cycles, processing element 0 receives in succession the triad (A0,B0,C0); in the next three cycles it receives the triad (A1,B1,C1); and in the next three cycles it receives the triad (A2,B2,C2), thus composing the initial window 80 that is shown in FIG. 3. During the same succession of cycles, other processing elements 28 will process windows 82 and 84.

This cyclic shift continues for N cycles until the window of each of processing element has slid over all N lines of the {A,B,C} data. Fetch units 46 will then load the {D,E,F} data, followed by {G,H,I}, as illustrated in FIG. 3, until the entire array of input data has been processed.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. Computational apparatus, comprising:
an input buffer configured to hold a first array of input data;
an output buffer configured to hold a second array of output data computed by the apparatus;
a plurality of processing elements, each processing element configured to compute a convolution of a respective kernel with a set of the input data that are contained within a respective window and to write a result of the convolution to a corresponding location in a respective plane of the output data;
one or more data fetch units, each coupled to read one or more segments of the input data from the input buffer; and
a shift register, which is coupled to receive the segments of the input data from the data fetch units and to deliver the segments of the input data in succession to each of the processing elements in an order selected so that the respective window of each processing element slides in turn over a sequence of window positions covering the first array, whereupon the result of the convolution for each window position is written by each processing element to the location corresponding to the window position in the respective plane in the output buffer.

2. The apparatus according to claim 1, wherein the processing elements are configured to compute a respective line of the output data in the second array for each traversal of the first array by the respective window, and wherein the data fetch units and the shift register are configured so that each of the segments of the input data is read from the input buffer no more than once per line of the output data and then delivered by the shift register to all of the processing elements in the succession.

3. The apparatus according to claim 1, wherein the shift register is configured to deliver the segments of the input data to groups of the processing elements such that in any given processing cycle of the processing elements, adjacent groups of the processing elements in the succession process the input data in different, respective windows.

4. The apparatus according to claim 1, wherein the shift register is configured to deliver the segments of the input data to groups of the processing elements such that in any given processing cycle of the processing elements, each segment of the input data is passed from one group of the processing elements to an adjacent group of the processing elements in the succession.

5. The apparatus according to claim 4, wherein the shift register comprises a cyclic shift register, such that a final processing element in the succession is adjacent, with respect to the cyclic shift register, to an initial processing element in the succession.

6. The apparatus according to claim 1, wherein each processing element comprises one or more multipliers, which multiply the input data by weights in the respective kernel, and an accumulator, which sums products output by the one or more multipliers.

7. The apparatus according to claim 1, wherein the input data held by the input buffer comprise pixels of an image.

8. The apparatus according to claim 1, wherein the input data held by the input buffer comprise intermediate results, corresponding to feature values computed by a preceding layer of convolution.

9. A method for computation, comprising:
receiving a first array of input data in an input buffer;
transferring successive segments of the input data from the input buffer into a shift register;
delivering the segments of the input data from the shift register in succession to each of a plurality of processing elements, in an order selected so that a respective window of each processing element slides in turn over a sequence of window positions covering the first array;
computing in each processing element a convolution of a respective kernel with a set of the input data that are contained within the respective window, as the respective window slides over the sequence of window positions, and writing a result of the convolution for each window position to a corresponding location in a respective plane in a second array of output data in an output buffer.

10. The method according to claim 9, wherein computing the convolution comprises computing a respective line of the output data in the second array for each traversal of the first array by the respective window, and wherein fetching the successive segments comprises reading each of the segments of the input data from the input buffer no more than once per line of the output data, and wherein delivering the segments comprises passing each of the segments of the input data from the shift register to all of the processing elements in the succession.

11. The method according to claim 9, wherein delivering the segments of the input data comprises passing the segments of the input data to groups of the processing elements such that in any given processing cycle of the processing elements, adjacent groups of the processing elements in the succession process the input data in different, respective windows.

12. The method according to claim 9, wherein delivering the segments of the input data comprises passing the segments of the input data to groups of the processing elements such that in any given processing cycle of the processing elements, each segment of the input data is passed by the shift register from one group of the processing elements to an adjacent group of the processing elements in the succession.

13. The method according to claim 12, wherein the shift register comprises a cyclic shift register, such that a final processing element in the succession is adjacent, with respect to the cyclic shift register, to an initial processing element in the succession.

14. The method according to claim 9, wherein computing the convolution comprises, in each processing element, multiplying the input data by weights in the respective kernel to give respective products, and summing the respective products.

15. The method according to claim 9, wherein the input data held by the input buffer comprise pixels of an image.

16. The method according to claim 9, wherein the input data held by the input buffer comprise intermediate results, corresponding to feature values computed by a preceding layer of convolution.
